(19) United States
(12) Patent Application Publication
(10) Pub. No.: US 2012/0034096 A1
(43) Pub. Date: Feb. 9, 2012

(54) INCORPORATION OF FUNCTIONAL CLOTH INTO PREPREG COMPOSITES

(75) Inventor: Steve Appleton, Fleet (GB)

(73) Assignee: VESTAS WIND SYSTEMS A/S, Randers SV (DK)

(21) Appl. No.: 13/265,467

(22) PCT Filed: Apr. 23, 2010
(86) PCT No.: PCT/GB2010/050665

§ 371 Date: Oct. 24, 2011

(30) Foreign Application Priority Data
Apr. 23, 2009 (GB) 0907011.1

(51) Int. Cl. F03D 11/00; B32B 33/00; B29C 39/12; B32B 37/12; B32B 7/08; B32B 3/10; B32B 3/06

(52) U.S. Cl. 416/241 A; 428/196; 428/91; 428/102; 156/60; 156/93; 156/148; 264/259

(57) ABSTRACT

Incorporation of functional cloth into prepreg composites A combined prepreg material (10) for use in composite lay-up techniques is described. The material (10) comprises first and second layers (12, 18) impregnated with a matrix material such as a resin. The first layer (12) is a functional layer and the second layer (18) is a keying layer. The keying layer (18) comprises a keying medium to facilitate bonding of the combined prepreg material (10) to a gel coat. The functional layer (12) comprises a woven cloth (14). A circuit is provided on a first surface (16) of the cloth (14).

### FIELD OF THE INVENTION

The present invention relates to prepreg composite materials and to gel-coated composite structures such as wind turbine blades, which are fabricated from prepreg materials. More specifically, the present invention relates to the incorporation of functional cloth, such as radar absorbing material, into composite structures.

### BACKGROUND

It is known to incorporate materials having specific functionality into composite structures such as wind turbine blades. An example of this is the inclusion of radar absorbing material (RAM) into composite blades. This is done to reduce the radar reflectivity of the blades so that they do not interfere with radar systems such as air traffic control systems or marine radar systems.

Typical radar absorbing materials include “circuit analogue” (CA) absorbers. Plain weave glass-fibre cloth is a preferred substrate for such CA absorbers, because fibre movement, which could damage the CA absorbers, is lower for plain weave than for other weave types.

At present, it is known for plain weave cloth with deposited functionality to be introduced into gel-coated composite structures, such as wind turbine blades, fabricated using resin infusion or wet lay-up techniques. In these structures, the plain weave cloth is located significantly away from the outer surface defined by the gel coat, and hence the deposited functionality is also significantly away from the outer surface; here, the deposited functionality may be less effective and its consistent and predictable location in the structure may be difficult to ensure. In RAM applications especially, it is important for deposited functionality to be positioned at a consistent and predictable location in the structure in terms of depth from the outer surface. Also, the deposited functionality could include a de-icing circuit that clearly needs to be close to the outer surface of the structure to work effectively.

### SUMMARY OF THE INVENTION

According to a first aspect of the present invention, there is provided a combined prepreg material for use in composite lay-up techniques, the material comprising first and second layers impregnated with a matrix material such as a resin; the first layer being a functional layer and the second layer being a keying layer that comprises a keying medium to facilitate bonding of the combined prepreg material to a gel coat, wherein: the functional layer comprises a woven cloth; and a circuit is provided on a first surface of the woven cloth.

In contrast to the prior art, which is generally concerned with resin-infusion and wet lay-up techniques, the present invention is concerned with prepreg techniques. When the combined prepreg material is used in the fabrication of a gel-coated composite structure, the keying layer facilitates bonding of the functional layer to the gel coat. Only the keying layer is disposed between the functional layer and the gel-coat. This enables the functional layer to be disposed conveniently close to the outer surface of the composite structure. The keying layer advantageously prevents “print-through” of the weave pattern of the first layer onto the outer surface of the composite structure, thereby ensuring a good surface finish. In addition to these advantages, the combined prepreg material is easier to handle than separate functional and keying layers and so facilitates composite lay-up.

The circuit may be provided using conductive materials using known deposition techniques. The circuit may form a circuit analogue absorber for absorbing radar signals. However, in other examples, circuitry could be provided on the first surface of the cloth. For such applications, a silver-loaded ink would be suitable. In yet further embodiments, resistive circuit elements could be provided on the first surface. In the resulting composite structure, the resistive elements would be close to a gel-coated outer surface, and so would be suitably positioned for use as a de-icing network, for example when the composite structure is a wind turbine blade.

The woven cloth of the functional layer may be a glass-fibre cloth, or may be formed from other suitable reinforcing fibres, for example carbon fibres. The woven cloth preferably has a low-movement weave such that fibre movement is low and hence breaking of circuit elements is substantially avoided. A plain weave is an example of a low-movement weave. Preferably, the cloth is plain weave E-glass. The cloth is preferably thin, for example in the region of 184 gsm (grams per square metre).

When the combined prepreg material is used in the fabrication of gel-coated composite structures such as wind turbine blades, the keying layer is the only material between the functional layer and the outer surface of the composite structure defined by the gel coat. A keying layer of substantially uniform thickness may advantageously be employed in the combined prepreg material to ensure that the circuit is located at a consistent and predictable location in the composite structure in terms of depth from the outer surface. This ensures effective operation when the circuit is for RAM purposes, for example.

The keying medium may be a layer of non-woven glass-fibre tissue or fleece. Alternatively, the keying medium may be any other suitable material capable of keying into the gel-coat. Preferably, the keying layer is a thin layer, for example in the region of 50 gsm. A thin keying layer may advantageously be employed to ensure that the circuit is close to the outer surface of the composite structure. This is beneficial when the functionality is for de-icing purposes.

Gel-coated composite structures such as wind turbine blades generally have a layer of structural cloth close to their outer surface. When such composite structures are fabricated using a combined prepreg material according to the present invention, the functional layer is located between this structural layer and the keying layer/gel coat. In certain embodiments, the combined prepreg material may additionally include a third layer being a structural layer and comprising a cloth having a structural weave, for example a triaxial weave. Inclusion of a structural layer in the combined prepreg material facilitates composite lay-up because fewer layers are required to be separately assembled on a mould.

It is considered preferable to have the circuit at the interface between the functional and structural layers, rather than at the interface between the functional layer and the keying layer/gel coat. Accordingly, it is preferable that the keying layer of the combined prepreg material is adjacent to a second surface of the woven cloth, the second surface being opposite the first surface. This is because it is believed that the bond between the functional layer and the structural layer is stronger than the bond to the gel coat via the keying layer. Hence, having the circuit at the interface between the functional and structural layers is considered less likely to result in delamination in the resulting composite structure than if the functionality is at the interface between the functional layer and the keying layer/gel coat. However, in certain embodiments of the invention, it may be desirable to have the keying layer adjacent the first surface so that the circuit is at the interface between the functional layer and the keying layer, and hence is closer to the gel coat.

The layers of the combined prepreg material may be stitched or otherwise attached in order to hold the layers together without wrinkles, gaps or voids so that when the materials are impregnated with the matrix material, a consistent product is obtained. Coded stitching, for example colour coding or stitching patterns, may be used to identify a characteristic of the functional layer. This provides a visual indication of the functionality of the resulting combined prepreg material.

According to a second aspect of the present invention, there is provided a method of manufacturing a combined prepreg material for use in composite lay-up techniques, the method comprising assembling first and second layers and impregnating the first and second layers with a matrix material such as a resin; the first layer being a functional layer and the second layer being a keying layer that comprises a keying medium to facilitate bonding of the combined prepreg material to a gel coat, wherein: the functional layer comprises a woven cloth; and a circuit is provided on a first surface of the woven cloth. It will be apparent that the first and second aspects of the invention are product and method counterparts.

The method may comprise assembling a third layer with the first and second layers and impregnating the first, second and third layers with the matrix material; the third layer being a structural layer comprising a cloth having a structural weave.

The method may comprise attaching the layers together prior to impregnating the layers with the matrix material. For example, the layers may be stitched. Advantageously, the method may comprise attaching the three layers together at the same time as weaving the cloth of the structural layer.

According to a third aspect of the present invention within the overall inventive concept, there is provided a method of fabricating a composite structure having a gel coat defining an outer surface and a functional layer beneath the gel coat, the method including: applying the gel coat within a mould; laying a combined prepreg material on the gel coat, the combined prepreg material comprising first and second layers impregnated with a matrix material such as a resin; the first layer being a functional layer and the second layer being a keying layer that comprises a keying medium to facilitate bonding of the combined prepreg material to the gel coat, wherein: the functional layer comprises a woven cloth; and a circuit is provided on a first surface of the cloth; and the method further comprises curing the composite structure.

It will be appreciated that the combined prepreg material used in the above method may comprise some or all of the features of the combined prepreg materials described previously. For example, it may also comprise the structural layer. However, for conciseness, the optional features of the combined prepreg material are not repeated herein.

The inventive concept includes the use of a combined prepreg material as described above in the fabrication of gel-coated composite structures. Further, the inventive concept encompasses composite structures fabricated using a combined prepreg material as described above. The composite structure may have a gel coat defining an outer surface. The combined prepreg material may be bonded to the gel coat via the keying layer. The composite structure may be a blade for a wind turbine. The inventive concept extends to a wind turbine having a blade fabricated using a combined prepreg material as described above, and to a wind farm comprising at least one such wind turbine.

### BRIEF DESCRIPTION OF THE DRAWINGS

Specific embodiments of the invention will now be described, by way of example only and without limitation to the scope of the invention, with reference to the following figures, in which:

FIG. 1a is a schematic cross-section of a combined prepreg material comprising a functional cloth layer and a keying layer for keying to a gel coat;

FIG. 1b is a schematic cross-section of a lay-up for the fabrication of a composite structure such as a wind turbine blade, in which the combined prepreg material of FIG. 1a is laid on a gel coat in a mould, and one or more layers of prepreg structural cloth are laid on top of the combined prepreg material;

FIG. 1c is a schematic cross-section showing the layers of FIG. 1b assembled in the mould and a vacuum bag applied over the assembly for curing the resulting composite structure;

FIG. 1d is a schematic cross-section showing the cured composite structure of FIG. 1c released from the mould;

FIG. 2a is a schematic cross-section of a combined prepreg material comprising a structural cloth layer, a functional cloth layer, and a keying layer for keying to a gel coat;

FIG. 2b is a schematic cross-section of a lay-up for the fabrication of a composite structure such as a wind turbine blade, in which the combined prepreg material of FIG. 2b is laid on a gel coat in a mould;

FIG. 2c is a schematic cross-section showing the layers of FIG. 2b assembled in the mould and a vacuum bag applied over the assembly for curing the resulting composite structure; and

FIG. 2d is a schematic cross-section showing the cured composite structure of FIG. 2c released from the mould.

### DETAILED DESCRIPTION

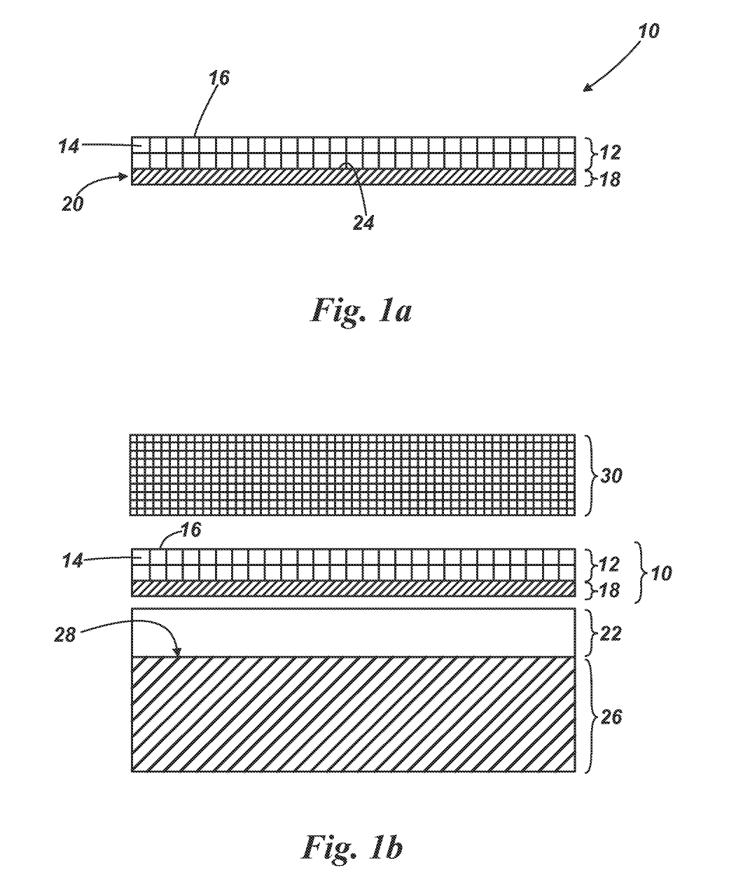

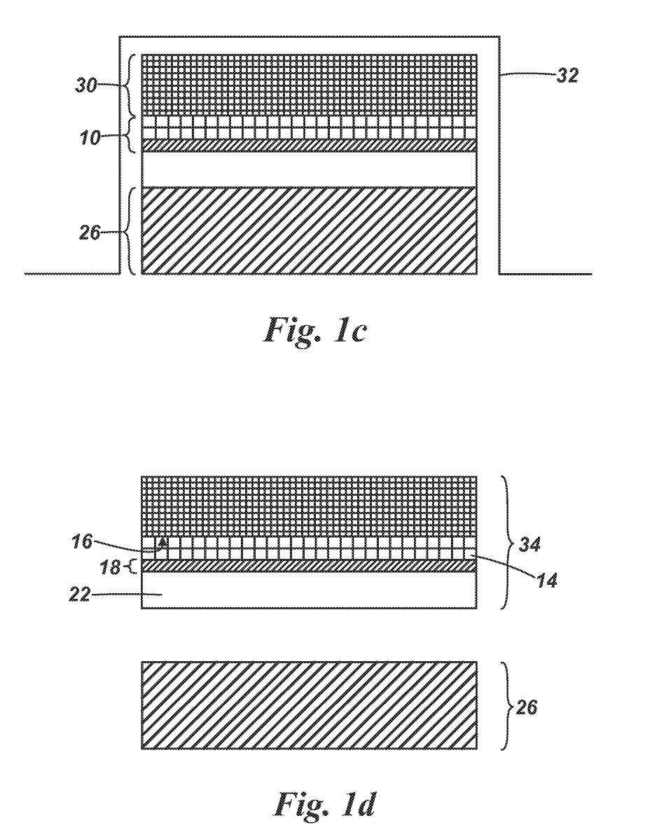

Referring to FIG. 1a, there is shown a combined prepreg material 10 having a functional layer 12 comprising a glass-fibre cloth 14 that is provided on a first surface 16 with a circuit (not shown) to form part of a CA absorber for absorbing radar signals. The circuit may be provided on the first surface 16 using conventional manufacturing techniques, such as depositing. In this example, the glass-fibre cloth 14 has a low-movement weave, and is plain weave E-glass having a weight of 184 gsm (grams per square metre). A keying layer 18, comprising a keying medium 20 for facilitating bonding to a gel coat 22 (FIG. 1b), is disposed on a second surface 24 of the plain weave cloth 12, opposite the first surface 16. In this example, the keying medium 20 is a thin layer of lightweight E-glass tissue, having a uniform fibre dispersion and a weight of 50 gsm.

The functional layer 12 and the keying layer 18 are stitched together and then impregnated with a matrix material such as a curable epoxy resin to bind the layers 12, 18 together. The stitching does not impart significant mechanical strength to the combined prepreg material 10, but instead is used as a means to hold the layers 12, 18 together without wrinkles, gaps or voids so that when the materials are impregnated with resin, a consistent product is obtained. As there may be a requirement to produce combined prepreg materials having different functionality, coded stitching (for example using different coloured stitches) can be used to identify the particular functional layer 12 in the combined prepreg material.

The combined prepreg material 10 is easier to lay-up than separate thin layers of tissue and E-glass, and may be advantageously utilised in the fabrication of composite structures such as wind turbine blades. The fabrication of a composite structure, such as a wind turbine blade, utilising the combined prepreg material 10 will now be described with reference to FIGS. 1b, 1c and 1d. Referring first to FIG. 1b, a mould 26 is provided having a mould surface 28 corresponding in shape to the required outer contour of the structure. A suitable release agent (not shown) is applied to the mould surface 28, and a pigmented epoxy resin gel coat 22 is applied on top. The combined prepreg material 10 is then laid on top of the gel coat 22, with the tissue layer 18 in contact with the gel coat 22. The tissue 18 keys into the gel coat 22 and hence facilitates a strong bond with the gel coat 22.

A layer of structural cloth 30 is laid over the first surface 16 of the plain weave cloth 14. In this example, the structural cloth 30 is prepreg Triax™, which is available from suppliers such as Gurit™ or Hexcel™. Triax™ is an example of a glass-fibre cloth having a triaxial weave, and is woven from three separate yarn sets, such that the fibres are orientated at respective angles of 0 and +/−45 degrees in the weave.

In this example, the circuit is at the interface between the functional cloth layer 12 and the structural cloth layer 30. At present, it is considered preferable to have the circuit on the side of the plain weave cloth 14 facing the structural cloth layer 30 rather than on the side of the plain weave cloth 14 that faces the gel coat 22. This is because the bond strength between the plain weave cloth 14 and the structural cloth layer 30 is understood to be stronger than the bond strength to the gel coat 22, and so it is considered undesirable to introduce materials at the interface with the gel coat 22 that could weaken this bond.

Whilst not shown in FIG. 1b, the lay-up may include further materials on top of the structural layer 30, in accordance with the specific structural requirements of the composite structure. For example, when the structure is a wind turbine blade, a foam core layer (not shown) may be laid on top of the structural cloth layer 30. Additionally, a RAM back-reflector (not shown), for example a carbon tissue layer (not shown), may be provided in this region.

Referring now to FIG. 1c, having assembled the prepreg materials 10, 30 on the gel-coated mould 26, the entire assembly is baked in a vacuum bag 32 to cure the resin.

Referring to FIG. 1d, once curing is complete, the resulting gel-coated composite structure 34 is released from the mould 26. The circuit (not shown) provided on the first surface 16 of the glass-fibre cloth 14 is advantageously close to, and at a consistent depth from, the outer surface of the composite structure defined by the gel coat 22. A strong bond with the gel coat 22 is facilitated by the E-glass tissue 18. In addition, the E-glass tissue 18 provides a good covering of the texture of the underlying glass-fibre cloth 14 and results in the composite structure 34 having a smooth outer surface, i.e. the E-glass tissue substantially prevents “print-through” of the weave of the glass-fibre cloth 14 on the outer surface of the composite structure 34. The cured gel coat 22 provides a high quality and highly durable UV- and hydrolysis-resistant coating on the external surface of composite structure 34.

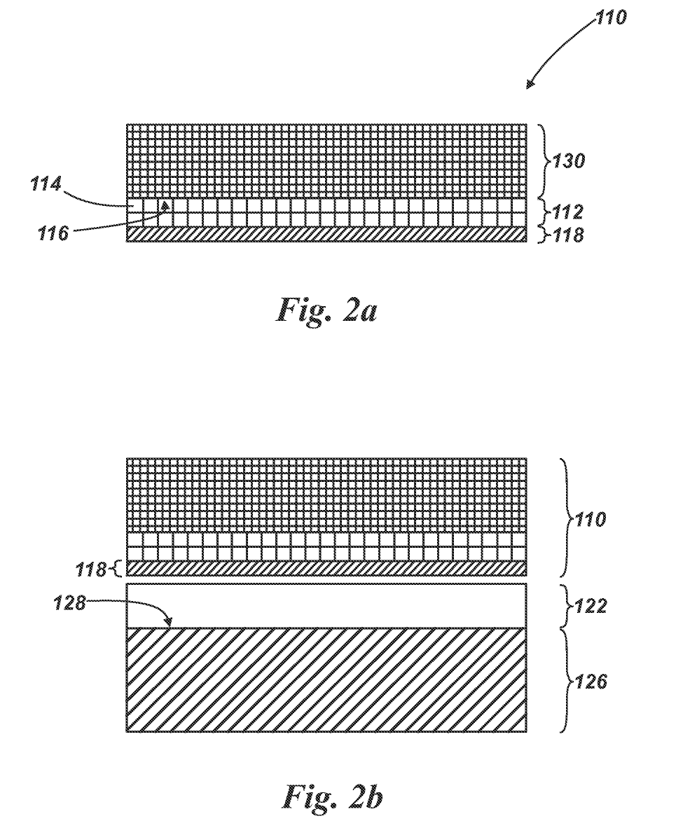

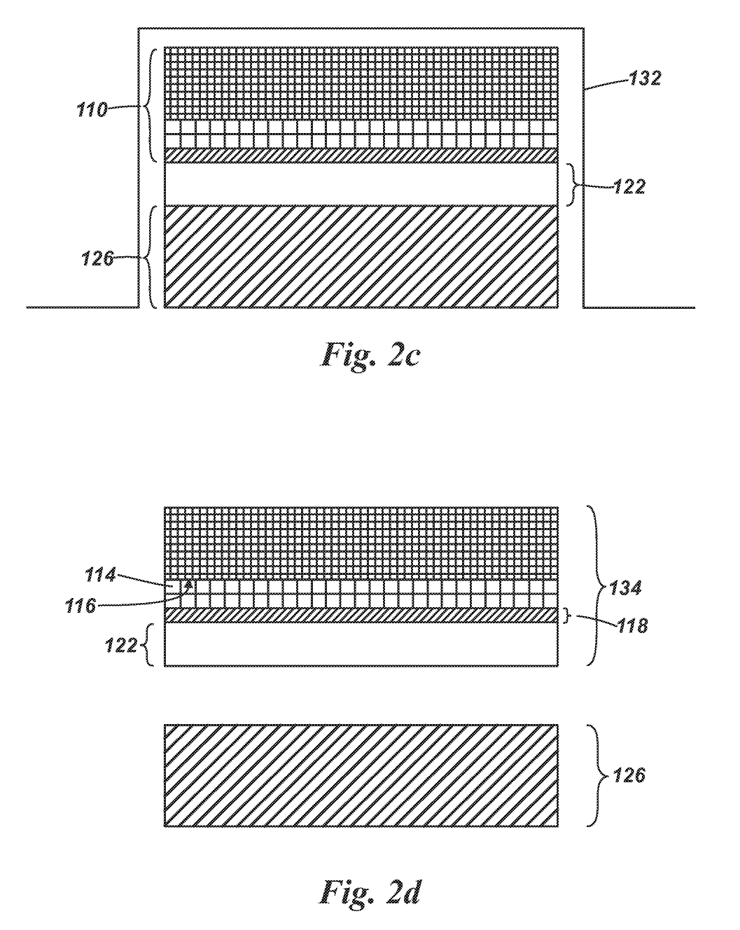

FIG. 2a shows a tri-layer combined prepreg material 110 in which a functional layer 112 is disposed between a keying layer 118 and a structural layer 130. In common with the embodiment shown in FIG. 1a, the functional layer 112 comprises a layer of 184 gsm plain weave E-glass 114, provided on a first surface 116 with a circuit (not shown), and the keying layer 118 comprises 50 gsm glass-fibre tissue. The structural layer 130 is a layer of Triax™. The functional layer 112, the keying layer 118 and the structural layer 130 are bound together by virtue of being impregnated with a curable epoxy resin to form the combined prepreg material 110.

The tri-layer combined prepreg material 110 is preferably manufactured simultaneously with the Triax™ layer 130. Triax™ is manufactured using an industrial weaving machine configured to weave glass fibres from three separate yarn sets. At the same time as the Triax™ is woven from the three yarn sets, the tissue layer 118 and the plain weave E-glass 114 are co-fed through the weaving machine. The weaving machine is configured to stitch together the Triax™ 130, the plain weave 114 and the tissue 118.

It will be appreciated that instead of co-feeding the tissue 118 and plain weave 114 through the weaving machine whilst the Triax™ 130 is manufactured, the Triax™ 130 could be prepared separately, and the three layers subsequently stitched together. Once the three layers have been stitched together, they are impregnated with the curable epoxy resin to form the combined prepreg material 110.

The tri-layer combined prepreg material 110 is a particularly convenient material for use in the fabrication of wind turbine blades, in order to include a functional layer close to the outer surface of the blade. Many existing blades have a structural cloth layer such as Triax™ as their outermost reinforced layer. By incorporating a structural cloth layer 130 such as Triax™ within the combined prepreg material 110, the fabrication of the composite blade is simplified, because fewer separate layers are required to be assembled in the mould. Thus, the tri-layer combined prepreg 110 facilitates handling of materials during the lay-up process.

The fabrication of a composite structure, such as a wind turbine blade, utilising the tri-layer combined prepreg material 110 of FIG. 2a will now be described with reference to FIGS. 2b, 2c and 2d. Referring first to FIG. 2b, a mould 126 is provided having a mould surface 128 corresponding in shape to the required outer contour of the structure. A release agent (not shown) is applied to the mould surface 128 and a gel coat 122 is applied on top. The mould surface 128 and the tri-layer combined prepreg material 110 is laid on top of the gel coat 122, with the tissue layer 118 of the combined prepreg material 110 in contact with the gel coat 122.

Additional core layers (not shown) may be provided on top of the tri-layer combined prepreg 110 in accordance with the required structural properties of the composite structure. Referring now to FIG. 2c, having laid the combined prepreg material 110, and any further prepreg materials (not shown) on the gel-coated mould 126, the entire assembly is baked in a vacuum bag 132 to cure the resin.

Referring to FIG. 2d, once curing is complete, the resulting gel-coated composite structure 134 is released from the mould 126. The circuit (not shown) provided on the first surface 116 of the glass-fibre cloth 114 is advantageously close to, and at a consistent depth from, the outer surface of the composite structure 134 defined by the gel coat 122. A strong bond with the gel coat 122 is facilitated by the tissue layer 118.

Whilst the examples described above relate to the incorporation of radar absorbing materials into composite structures such as wind turbine blades, it will be appreciated that this is only one example of the type of functionality that can be incorporated using the above techniques. For example, the plain weave cloth 14, 114 could instead be provided with circuitry to provide a means for routing signals around a composite structure such as a wind turbine blade. For this purpose, an ink, such as a silver-loaded ink, could be provided on the plain weave cloth. Other applications could include deposited circuitry for use in de-icing blades. For de-icing purpose, it is particularly advantageous to be able to incorporate the functionality as close as possible to the outer surface of the blade.

Aside from wind turbine applications, it will be appreciated that the above techniques and combined prepreg materials can be used in any other gel-coated prepreg composite structures where it is required to introduce functionality close to the gel-coated outer surface.

Whilst glass-fibre reinforcing materials have been described herein, it will be appreciated that variants of the invention may utilise alternative reinforcing fibres, for example carbon fibres. It will also be appreciated that whilst stitching is specifically described as a means of holding the various layers together prior to impregnation with the matrix material, other suitable means of attachment could be employed for this purpose. Furthermore, it will be appreciated that attaching the layers together prior to impregnation with the matrix material is not essential.

Various other modifications may be made to the examples above without departing from the scope of the invention as defined by the following claims.

1. A combined prepreg material for use in composite lay-up techniques, the material comprising first and second layers impregnated with a matrix material such as a resin; the first layer being a functional layer and the second layer being a keying layer that comprises a keying medium to facilitate bonding of the combined prepreg material to a gel coat, wherein: the functional layer comprises a woven cloth; and a circuit is provided on a first surface of the woven cloth.

2. The combined prepreg material as claimed in claim 1, wherein the keying layer is adjacent to a second surface of the cloth, the second surface being opposite the first surface.

3. The combined prepreg material as claimed in claim 1, further comprising a third layer being a structural layer and comprising a cloth having a structural weave; wherein the first, second and third layers are impregnated with the matrix material.

4. The combined prepreg material as claimed in claim 3, wherein the functional layer is disposed between the keying layer and the structural layer.

5. The combined prepreg material as claimed in claim 1, wherein the circuit is in the form of a circuit analogue absorber for absorbing radar signals.

6. The combined prepreg material as claimed in claim 1, wherein the woven cloth has a low-movement weave, such as a plain weave.

7. The combined prepreg material as claimed in claim 1, wherein the keying medium is a tissue or fleece.

8. The combined prepreg material as claimed in claim 3, wherein the structural weave is a triaxial weave.

9. The combined prepreg material as claimed in claim 1, wherein the layers are stitched together.

10. The combined prepreg material as claimed in claim 9, wherein coded stitching is used to identify a characteristic of the circuit.

11. A method of manufacturing a combined prepreg material for use in composite lay-up techniques, the method comprising assembling first and second layers and impregnating the first and second layers with a matrix material such as a resin; the first layer being a functional layer and the second layer being a keying layer that comprises a keying medium to facilitate bonding of the combined prepreg material to a gel coat, wherein: the functional layer comprises a woven cloth; and a circuit is provided on a first surface of the woven cloth.

12. The method of claim 11, further comprising assembling a third layer with the first and second layers and impregnating the first, second and third layers with the matrix material; the third layer being a structural layer comprising a cloth having a structural weave.

13. The method of claim 11, further comprising attaching the layers together prior to impregnating the layers with the matrix material.

14. The method of claim 13, wherein the layers are stitched together prior to impregnating the layers with the matrix material.

15. The method of claim 12, further comprising attaching the three layers together at the same time as weaving the cloth of the structural layer.

16. A composite structure fabricated using a combined prepreg material as claimed in claim 1.

17. The composite structure as claimed in claim 16 and having a gel coat defining an outer surface, wherein the combined prepreg material is bonded to the gel coat via the keying layer.

18. The composite structure as claimed in claim 16, wherein the composite structure is a blade for a wind turbine.

19. A wind turbine having a blade according to claim 18.

20. A method of fabricating a composite structure having a gel coat defining an outer surface and a functional layer beneath the gel coat, the method including:
applying the gel coat within a mould;
laying a combined prepreg material on the gel coat, the combined prepreg material comprising first and second layers impregnated with a matrix material such as a resin; the first layer being a functional layer and the second layer being a keying layer that comprises a keying medium to facilitate bonding of the combined prepreg material to the gel coat, wherein: the functional layer comprises a woven cloth; and a circuit is provided on a first surface of the cloth; and
curing the composite structure.

21. (canceled)
